(19) United States
(12) Patent Application Publication
(10) Pub. No.: US 2016/0302434 A1
(43) Pub. Date: Oct. 20, 2016

(54) Collagen Casings Having Increased Final Moisture Content and Method of Production

(71) Applicant: Nitta Casings Inc., Bridgewater, NJ (US)

(72) Inventors: Steven J. Hatch, III, Phillipsburg, NJ (US); Mydiam Soto, Perth Amboy, NJ (US); Gary Seibel, Phillipsburg, NJ (US)

(21) Appl. No.: 15/130,457

(22) Filed: Apr. 15, 2016

Related U.S. Application Data
(60) Provisional application No. 62/148,475, filed on Apr. 16, 2015.

(51) Int. Cl. A22C 13/00

(52) U.S. Cl. CPC A22C 13/0016; A22C 2013/004

(57) ABSTRACT

Collagen casings having a final moisture content of between about 18.5% to 21.5% by weight may be produced by controlling the drying process for a collagen casing ready for drying. The collagen casing is treated with a suspension of polysorbate in vegetable oil following the drying process. The resulting collagen casing does not require treatment in a humidification chamber to increase the moisture content of the casing prior to shirring.

This application claims priority pursuant to 35 U.S.C. §119(e) to U.S. Provisional Patent Application No. 62/148,475 filed on Apr. 16, 2015, the entire contents of which are hereby incorporated in their entirety.

### BACKGROUND OF THE INVENTION

Reconstituted collagen is used in the manufacture of tubular casings for meats, such as sausages. The collagen used in these casings is usually derived from the corium layer of bovine hides. The collagen raw material is comminuted, and mixed with a swelling agent to produce a uniform dispersion from which a continuous tube is formed. The tube is then neutralized by the injection of gaseous ammonia or by contact with a liquid salt solution. The casing is washed in water to remove neutralization salts, plasticized by passing it through successive liquid baths and dried while inflated. Examples of such processes are disclosed in U.S. Pat. Nos. 3,535,125, 3,821,439, 4,388,331, and 5,820,812, the entire contents of each of which are hereby incorporated by reference.

Typically, collagen casings are dried to a moisture content of about 12-14% by weight and reeled prior to finishing. In the finishing process, the collagen casings must be treated in a humidification chamber to increase the moisture content of the casing prior to shirring. It would be desirable to develop a process for manufacturing collagen casings that have a sufficiently high final moisture content such that the casing does not require treatment by humidification prior to shirring.

### SUMMARY OF THE INVENTION

Edible collagen tubular casing is produced having an increased final moisture content compared to prior collagen casings. The final moisture content is sufficient to eliminate the need to treat the collagen casing by humidification prior to shirring. The final moisture content of the collagen casing is between about 18.5% to about 21.5% by weight.

The final moisture content of the collagen casing is controlled by adjusting the conditions in the dryer, such as temperature, time and humidity level. Following drying, a mixture of vegetable oil and polysorbate is applied to the to the collagen casing to prevent drying and to maintain the moisture in the casing at the desired level.

Among the advantages of the process are that the collagen casings do not require treatment by humidification prior to shirring. This allows elimination of humidification equipment at the final processing facility, thereby reducing the time and cost required for final processing of the collagen casing. Other advantages of the process of the present invention will be apparent to one skilled in the art based upon the Description of Embodiments of the Invention set forth below.

### BRIEF DESCRIPTION OF THE DRAWINGS

FIG. 1 is a schematic showing one embodiment of a prior process by which limed hides are processed into edible casings.

FIG. 2 is a schematic showing one embodiment of the process wherein collagen casings having an increased final moisture content are produced.

### DESCRIPTION OF EMBODIMENTS OF THE INVENTION

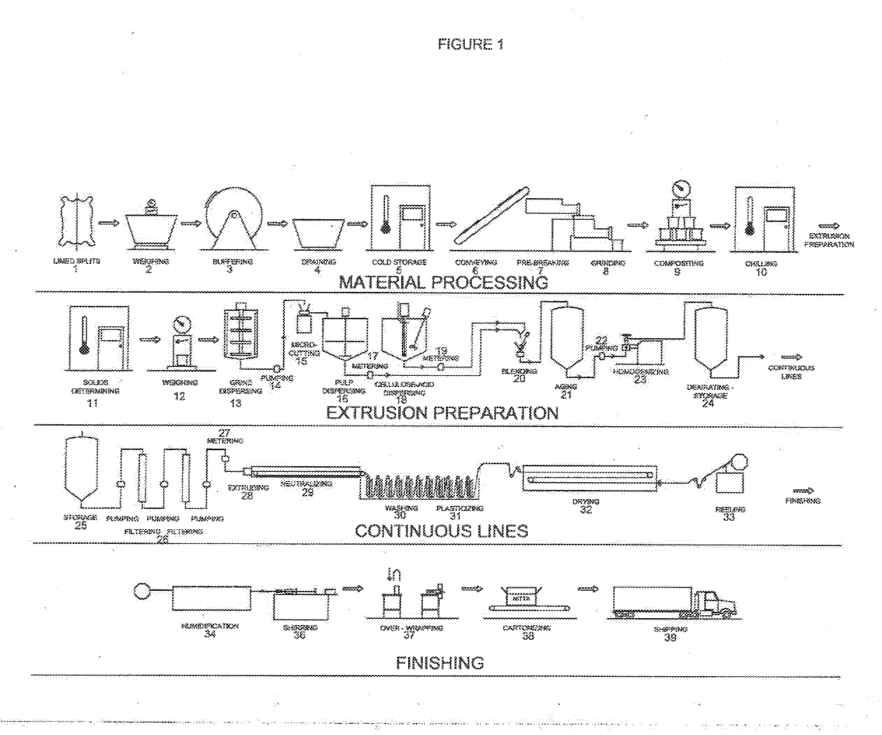

Conventional processes for producing edible collagen casings are known and have been described, for example, in U.S. Pat. No. 5,820,812, the entire contents of which are hereby incorporated by reference. The steps and equipment used in one embodiment of a typical process is shown schematically in FIG. 1. The invention is not limited in this regard, and collagen casing made by any process can be treated as described herein to achieve a desired final moisture content.

In one typical process for producing collagen casings, animal hides from freshly slaughtered animals are de-fleshed, washed with water, and treated with lime to remove hair. The lime treated animal hides are split on a leather splitting machine to separate the grain layer from the corium layer, which is used to produce the collagen casings. “Hides” is used in the description below to refer to the corium collagen layer of an animal hide that is used to produce the collagen casings. Referring to FIG. 1, the limed hides 1 may be stored in a refrigerated storeroom that is maintained at 0-4° C. until further processing as described below.

The hides are first processed to prepare the hide material for extrusion into casings. The hides are weighed 2 and treated in a buffering drum 3, which in one embodiment is capable of handling up to 3000 kg of product. In the buffering drum, the hides are first treated with an ammonium sulfate solution at a concentration in the range of about 0.5%-2.2% (w/w), then water washed. The hides are then further treated in the buffering drum with a citric acid/sodium citrate solution having a concentration of about 0.0725-0.29% (w/w), followed by another water wash. The buffering process brings the pH1 of the corium layer down to approximately 4.3 to 4.9. Assays are run to ensure the product reaches the appropriate pH. The buffered hides are drained 4 and the buffered hides are placed in cold storage 5 until needed for further processing.

When additional material is needed for processing, the hides are sent on a conveyor 6 to be shredded 7 and ground 8 into a quarter grind (i.e., a material having a particle size of about one-quarter inch) at less than approximately 25° C. The quarter grind material is composited 9 and chilled 10 and maintained at a temperature of about 18° C.

The chilled quarter grind material is piped to the extrusion preparation line. The solids are measured 11 and weighed 12 and the quarter grind particles are dispersed in water 13. The dispersed quarter grind is pumped 14 to a high speed cutting mill 15 where the hide particles are further shredded to form a hydrated mass. The hydrated mass is stored and kept mixed in a pulp dispersion tank 16. In a separate blending tank 18, a dispersion of cellulose, HCl and water at 0-10° C. is prepared. In one embodiment, the dispersion is prepared at 5° C.

A quantity of the hydrated quarter grind particles from the pulp dispersion tank 16 is metered 17 into a blender 20. At the same time, a quantity of the cellulose-acid dispersion from blending tank 18 is metered 19 into the blender 20 and blended with the hydrated quarter grind particles to form a gel product. After an initial blend period of about 15-60 minutes, the gel product is stored in an aging tank 21 for about 20 hours under vacuum. The temperature of the storage tank is maintained at less than 20° C. The gel product is then pumped 22 to a homogenizer 23 and sent to a storage tank 24 where it is deaerated under vacuum. The gel product so obtained has the following approximate composition:

| Ingredient | Percent |
|---|---|
| Hide Solids | 4.2 to 5.3 |
| Cellulose | 0.90 to 1.70 |
| Hydrochloric Acid | 0.20 to 0.24 |

The gel product is maintained in storage tank 25 at about 25° C. The gel product is pumped from the storage tank through a series of filters 26, which may be any appropriate type of filter. Automatic self cleaning filters may be used. The filtered gel product is metered 27 to the extruder 28 to form the collagen casing. The extruder is preferably a disk extruder. At the extruder, the gel is extruded to a thickness from 0.075 to 1.2 thousands of an inch, formed, and inflated pneumatically to the desired diameter, typically about 13-34 mm. The collagen casing is treated with anhydrous ammonia in the neutralizing section 29. The ammonia reacts with and neutralizes the HCl in the product and causes coagulation of the collagen. The neutralized collagen casing is washed in a fresh water bath 30 to remove ammonia salts. The washed collagen casing then travels through a series of baskets 31 containing a plasticizer. In one embodiment, the plasticizer solution is an aqueous solution containing about 2% to 6% glycerin, about 0.20% to 1.6% sodium carboxymethylcellulose or sodium alginate, and about 0 to 20 ppm sodium hypochlorite. This process dehydrates the casing for drying purposes and allows introduction of glycerin for elasticity purposes.

The collagen casing travels through a dryer 32. As shown in FIG. 1, in prior processes for manufacturing collagen casings, the moisture content of the collagen casing after drying was in the range of 3 to 5%. After drying, the collagen casing would be fed through a humidification chamber (not shown) at approximately 85% relative humidity prior to being collapsed and wound on a reel 33, and was then fed through a second humidification chamber where final moisture is added to the casing. During the finishing process, moisture is added back to the casing by humidification 34 prior to shirring 36.

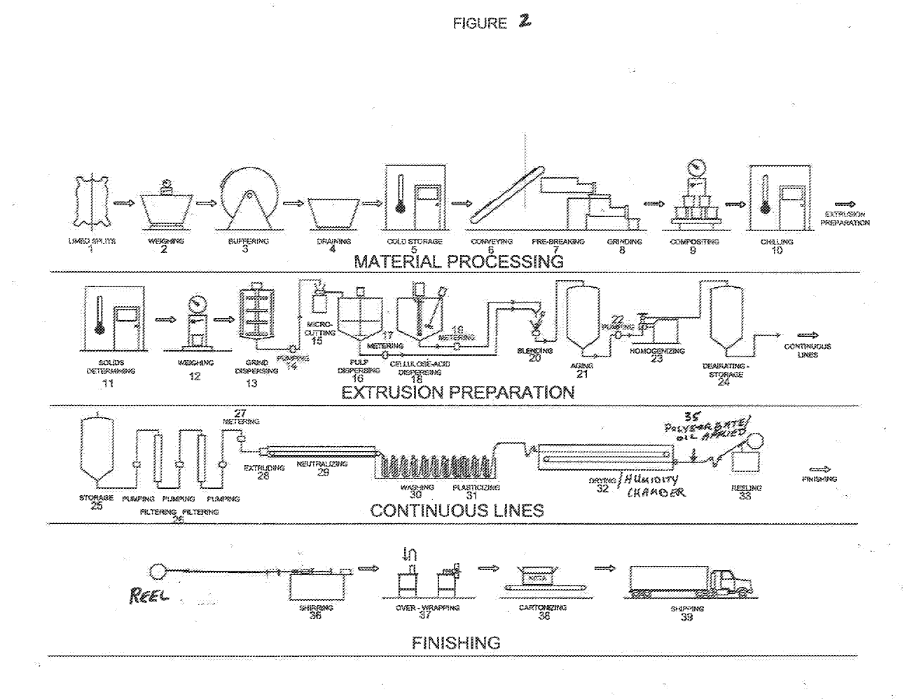

As illustrated in FIG. 2, in the present invention, a collagen casing is produced using a process similar to the process described above, with the drying process modified to produce a collagen casing having the desired final moisture content. The drying process is controlled to provide a collagen casing having a final moisture content of between about 18.5% to 21.5% by weight. In one embodiment, the final moisture content is about 19.5% by weight. As shown in FIG. 2, in the process of the present invention, collagen casing produced in the manner described above is dried in dryer and humidity chamber 32 by feeding the casing through three zones. In the first zone, the temperature within the dryer and humidity chamber is maintained at between about 150° F. and about 195° F. In the second zone, the temperature within the dryer and humidity chamber is maintained at between about 160° F. to about 205° F. In the third zone, the temperature is maintained at between about 130° F. to 150° F. The collagen casing is within each of the three zones for about 30 to 60 seconds.

In one embodiment of the process, the temperature within the first zone of the dryer and humidity chamber is about 190° F., the temperature within the second zone of the dryer and humidity chamber is about 200° F., and the temperature within the third zone is about 140° F. In this embodiment, the relative humidity in each zone is maintained at about 85 to 95%.

Following the drying and humidity chamber step, an oil based suspension of polysorbate in vegetable oil is applied to the collagen casing at room temperature 35. The polysorbate/oil based suspension prevents the collagen casing from sticking together and maintains the moisture content of the casing at the desired level. The amount of the polysorbate/vegetable oil suspension applied to the casing ranges from about 1% to about 6% of the total casing weight. In a preferred embodiment, the amount of the polysorbate/vegetable oil suspension applied to the ranges from about 3% to about 3.5% of the total casing weight. The polysorbate is mixed into the vegetable oil at a concentration ranging from about 0.3 to 1% (w/w). The collagen casing is reeled 33 and shipped for finishing. At the finishing location, the product is shirred 36 to its specified length and placed in boxes that are over wrapped and vacuum packed 37. The collagen casing of the invention does not require treatment by humidification prior to shirring.

As will be recognized by those of ordinary skill in the pertinent art based on the teachings herein, numerous changes and modifications may be made to the above-described and other embodiments of the invention without departing from its scope. Accordingly, this detailed description of preferred embodiments is to be taken in an illustrative as opposed to a limiting sense.

We claim:

1. A process for producing a collagen casing having an increased final moisture content comprising the steps of:
(a) providing a collagen casing wherein the collagen casing is ready for final drying;
(b) feeding the collagen casing through a dryer and humidification chamber, wherein the collagen casing is dried to a final moisture content of between about 18.5% to about 21.5% by weight;
(c) applying to the collagen casing a suspension of a polysorbate in vegetable oil.

2. The process of claim 1, wherein the collagen casing is fed through a dryer having a first drying zone maintained at a temperature between about 150° F. and 195° F., a second drying zone maintained at a temperature between about 160° F. and 205° F., and a third drying zone maintained at a temperature between about 130° F. and 150° F.

3. The process of claim 2, wherein the relative humidity in each of the drying zones is maintained between about 85% to 95%.

4. The process of claim 4, wherein the final moisture content of the collagen casing is about 19.5% by weight.

5. The process of claim 2, wherein the suspension of polysorbate in vegetable oil is applied in an amount of between about 1 to 6% of the total casing weight.

6. The method of claim 5, wherein the suspension of polysorbate in vegetable oil is applied in an amount of between about 3 to 3.5% of the total casing weight.

7. The method of claim 6, wherein the polysorbate comprises between about 0.3% to 1% w/w of the polysorbate/vegetable oil suspension.

8. A tubular collagen casing comprising collagen having a moisture content of between about 18.5% by weight to about 21.5% by weight and a suspension of polysorbate in vegetable oil on the outer surface of the collagen.

9. The tubular collagen casing of claim 8, wherein the final moisture content of the collagen casing is about 19.5% by weight.

10. The tubular collagen casing of claim 1, wherein the suspension of polysorbate in vegetable oil is between about 1% to about 6% of the total casing weight.

11. The tubular collagen casing of claim 10, wherein the suspension of polysorbate in vegetable oil is between about 3% to about 3.5% of the total casing weight.

12. The tubular collagen casing of claim 10, wherein the polysorbate comprises between about 0.3% to about 1% w/w of the polysorbate/vegetable oil suspension.
